(19) United States
(12) Patent Application Publication
(10) Pub. No.: US 2003/0075982 A1
(43) Pub. Date: Apr. 24, 2003

(54) Transfer switch

(76) Inventor: William J. Seefeldt, Monticello, MN (US)

Correspondence Address: Edward J. Kondracki, MILES & STOCKBRIDGE P.C., 1751 Pinnacle Drive, Suite 500, McLean, VA, 22102, US

(21) Appl. No.: 10/224,596

(22) Filed: Aug. 21, 2002

Related U.S. Application Data
(63) Continuation-in-part of application No. 09/547,233, filed on Apr. 11, 2000, now Pat. No. 6,420,801.
(60) Provisional application No. 60/313,483, filed on Aug. 21, 2001.

(51) Int. Cl. H02P 1/00

(52) U.S. Cl. 307/29

(57) ABSTRACT

Disclosed is an automatic electric transfer switch arrangement for connecting an alternate power source, which may be a standby generator to a residential unit in the event of a utility power outage. A control disposed in a sub-panel allows for the pre-selection of high power loads to reduce the total utility demand during peak demand periods. When the utility power is restored, the standby generator is disconnected and the utility power is reconnected. During a power outage, the high power load items that were pre-selected are disconnected from the generator to prevent the system requiring from more capacity than the generators capability. The load shed mode can be automatically activated remotely, via a wireless transceiver. Further disclosed is an ATS system that can monitor the power level at both the utility meter and standby generator due to it unique placement between the utility meter and the house breaker.

### RELATED APPLICATIONS

This application is a continuation-in-part of U.S. patent application Ser. No. 09/547,233, now U.S. Pat. No. 6,420,801 B1. The subject matter of said patent is incorporated herein by reference in its entirety. This application also claims the benefit of the filing date of provisional application Ser. No. 60/313,483 filed Aug. 21, 2001.

### FIELD OF THE INVENTION

This invention relates generally to control systems for utility power management to control the supply of electrical power in the event that a utility power company has its normal power supply interrupted and power needs to be automatically switched to an external generator and/or in the event of a high peak power demand and the need for load shed. More specifically, this invention relates to a system that allows for a number of high household current or high power usage loads to be selected to be supplied power from an auxiliary external generator during peak demand periods to lower the household demand load for power directly from the utility company.

### BACKGROUND OF THE INVENTION

In traditional transfer switches, it is common for the standby generator to control in-house loads either during a peak shaving requirement or during an emergency outage. However, because of the way these switches are wired, the circuits that are transferred to the generator for peak shaving are the same circuits that are controlled during emergency outages. These circuits cannot be changed except by physically rewiring the connections to the generator.

Most residential current transfer switches today are manual transfers. It requires the homeowner to physically start the standby generator and physically connect the load to the generator. Furthermore, in the existing systems the standby generator performs 100% of the power for outage and the same 100% of the power for load shed. There is no mutual splitting of loads. As a result the current systems are inefficient and require the homeowner to be present to start the standby generator. When power outages occur and the homeowner is absent, losses due to shortage from freezer turn off may occur.

### SUMMARY OF THE INVENTION

It is therefore an object of the invention to provide an automatic power transfer system that allows for an alternative power source in the event of a power outage as well as for a load shed system for selecting high current loads during peak demand periods.

It is further an object of the invention to provide for a wireless control system for a standby generator to automatically activate power transfer during power loss and load shed during conditions of peak demand.

It is further an object of the invention to provide for an ATS system that allows a utility company to wirelessly monitor meter data.

It is further an object of the invention to provide for an ATS system that allows a utility company to wirelessly monitor generator data.

It is yet another object of the invention to provide control circuitry for transfer switches which automatically selects a power source depending on the conditions and needs of the household.

The present invention is a unique TC-LSS sub panel that allows for generator loads to be reconfigured automatically, based on whether the generator is meeting a peak shaving request or responding to an emergency outage. During peak power times, the utility company has the ability to send a wireless signal to TC-LSS and command it to turn on an auxiliary generator to provide electric power to selected large loads within a residential home, such as the air conditioner, an electric stove and/or the water heater. In this way, the house breaker panel still receives power from the utility company to operate the other electronic equipment, such as lights, TV sets, VCRs, while the large load items are provided with power from the auxiliary generator thus reducing the overall power demand. This system reduces the possibility of loss of power during a peak demand time period due to overload of the system. Also, the utility gains the benefit of having the large loads taken off of its grid and lowering the total consumption from residential units, thus eliminating the need to purchase additional power on the spot market.

In addition, the power output of the generator can be directed to bypass the house breaker panel, and be fed directly to the TC-LSS. In this event, the power line that connects the generator to the house breaker panel is in an “open circuit” mode.

In accordance with the present invention an Automatic Transfer Switch (hereafter “ATS”) is placed between the meter and the panel to allow both utility power and generator power to be passed to the house breaker panel, depending on the condition monitored.

During power outages the control of the pre-selected high power loads is reversed. Upon a power outage a power transfer sequence is initiated where the utility power is totally disconnected and the output of the standby auxiliary generator is applied directly to the house breaker panel. However, prior to the transfer, the powerline to the pre-selected high current loads are opened or disconnected so that the generator is not required to provide full household power requirements for the household load.

The advantages of the present invention will be more fully appreciated from a reading of the following description, taken in conjunction with the accompanying drawings.

### BRIEF DESCRIPTION OF THE DRAWINGS

FIG. 1 is a concept drawing that shows a power flow diagram with the ATS between the meter and the house breaker panel of a residential unit, with power coming from the utility flowing serially through the meter, the ATS and feeding the house breaker panel.

FIG. 2 is a concept drawing that shows a power flow diagram which emergency operation voltage path, when the power to the residential unit from the utility is interrupted.

FIG. 3 shows the operation power flow in accordance with the present invention during peak shaving operation.

FIG. 4 shows a wiring hook up of the TC-DFM control panel according to the invention.

FIG. 4A shows a wiring hook up for a wireless transceiver according to the invention.

FIG. 5 shows a schematic of the TC-LSS sub-panel unit according to the invention.

FIG. 6 is a flow chart of the power transfer switch system for the DFM Master.

FIG. 7 is a flow chart of the power transfer switch system for the DFM Slave.

### DETAILED DESCRIPTION OF THE PREFERRED EMBODIMENTS

In accordance with the accompanying figures, the preferred embodiment of the invention will be described in detail.

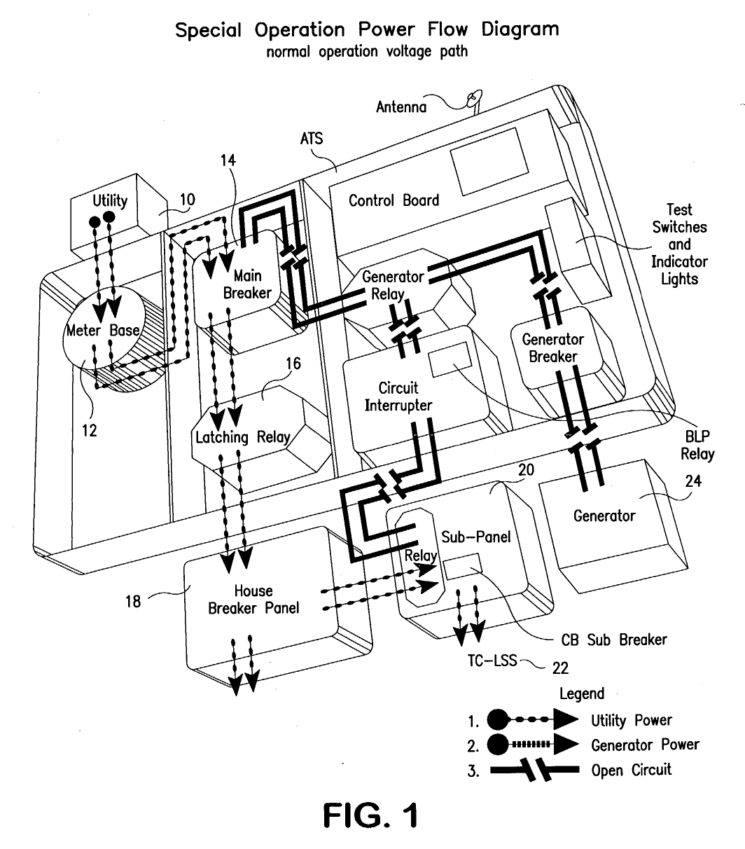

FIG. 1 illustrates the normal voltage path of utility power to a residential breaker panel from the household meter. The transmission path from the utility company starts with the utility (10) and proceeds to the Meter Base (12), through the Main Breaker (14), to the Latching Relay (16) and finally to the house breaker panel (18). The output from the panel (18) flows to household loads as well as sub-panel (20) and the TC-LSS (22). During the normal operation, the power from the generator (24) is not operatively connected to the load and is an “open circuit” as shown by the lines and openings therein. A control board controls the utility power.

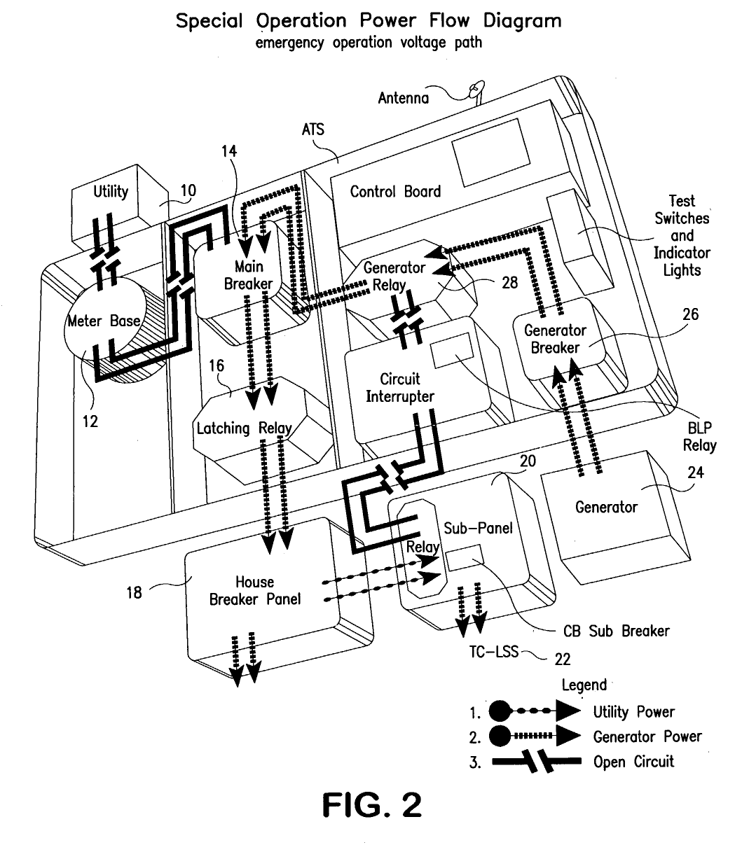

FIG. 2 illustrates the voltage path in the event of a power outage or emergency operation. The utility's power is off (that is, the voltage between the utility (10) and the meter base (12) is zero and there is an open circuit), and the generator (24) is turned on. The generator voltage path starts with the generator (24) and proceeds through the generator breaker (26) and then to the generator relay (28). From this point, the power is relayed to the transfer switch. The Latching Relay (16) opens to prevent back-feed to utility and the power is transferred to the house breaker panel (18). Sub-panel (20) receives power from breaker panel (18) and feed TC-LSS (22) to power selected loads.

When power from the utility is lost the generator (24) must go into an emergency power mode, so that the generator (24) will control the household electric devices. However, the generator may not have enough capacity to supply power to an entire household load. In that event, the TC-LSS sub-panel will therefore automatically reconfigure the circuits controlled by the generator so that the load does not exceed the generator's capacity.

An arrangement for connecting an alternative power supply such as a standby generator to provide residential power during power outage is disclosed in U.S. Pat. No. 6,420,801 (Seefeldt), which is hereby incorporated by reference in its entirety.

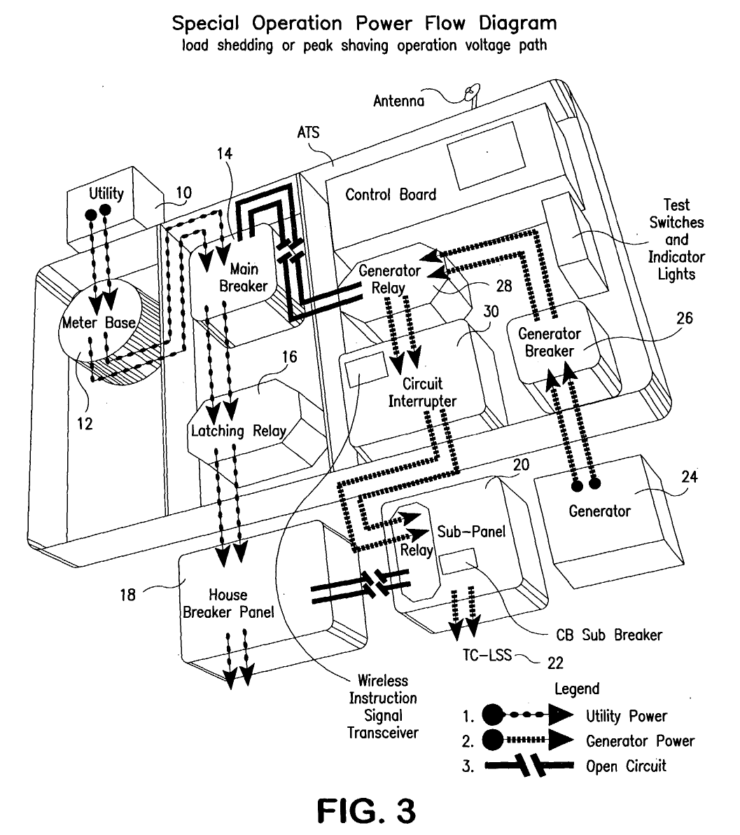

FIG. 3 depicts the voltage path during special operation for load shedding or peak shaving during high demand periods. In this figure, a wireless instruction signal (32) to the ATS from the utility company is received to command the DFM to turn on the generator (24) to run certain selected large loads within the household through the subpanel (20). The voltage path in this case starts with the generator (24) and flows to the generator breaker (26), then it proceeds to the circuit interrupter (30) and finally to the sub-panel (20) and TC-LSS (22). As depicted in FIG. 3, in this case the house breaker panel (18) is still receiving power from the utility, as illustrated in FIG. 1, while the generator (24) is being routed directly to the TC-LSS (22). The switch between the house breaker panel (18) and the sub-panel (20) is in open circuit mode to prevent “line feed back” or complicated synchronous operation.

The present power source management system has two transfer control boards with monitoring circuits. One control board responds to the standard power outage as to a wireless signal from the utility company and signals the standby generator (24) to turn on. The other control board (TC-DFM) controls the load shedding operation and is located in the sub-panel (20).

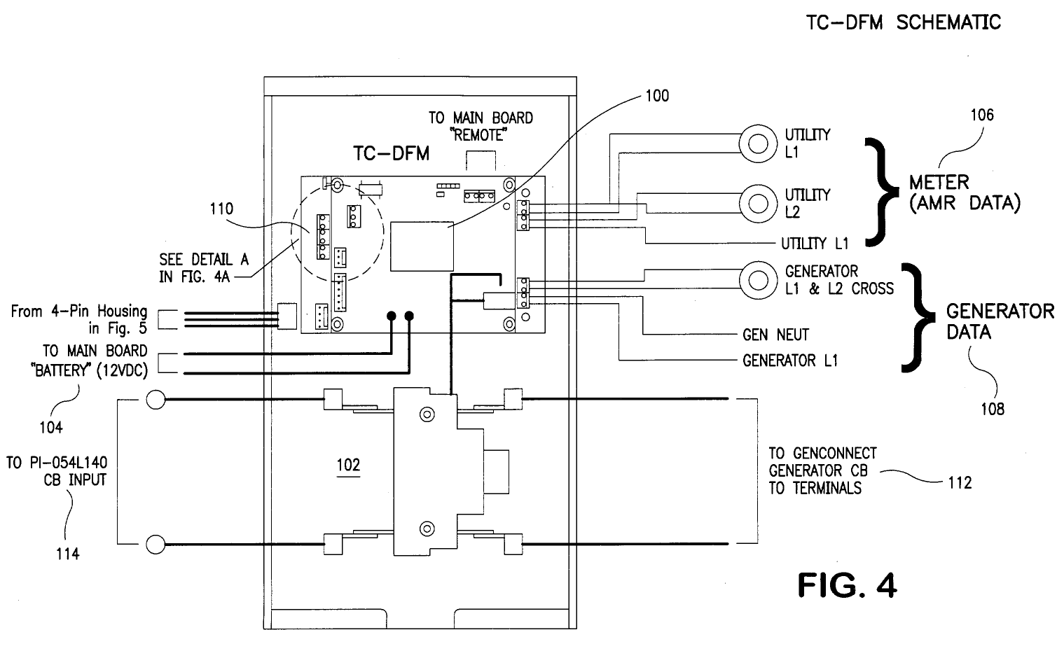

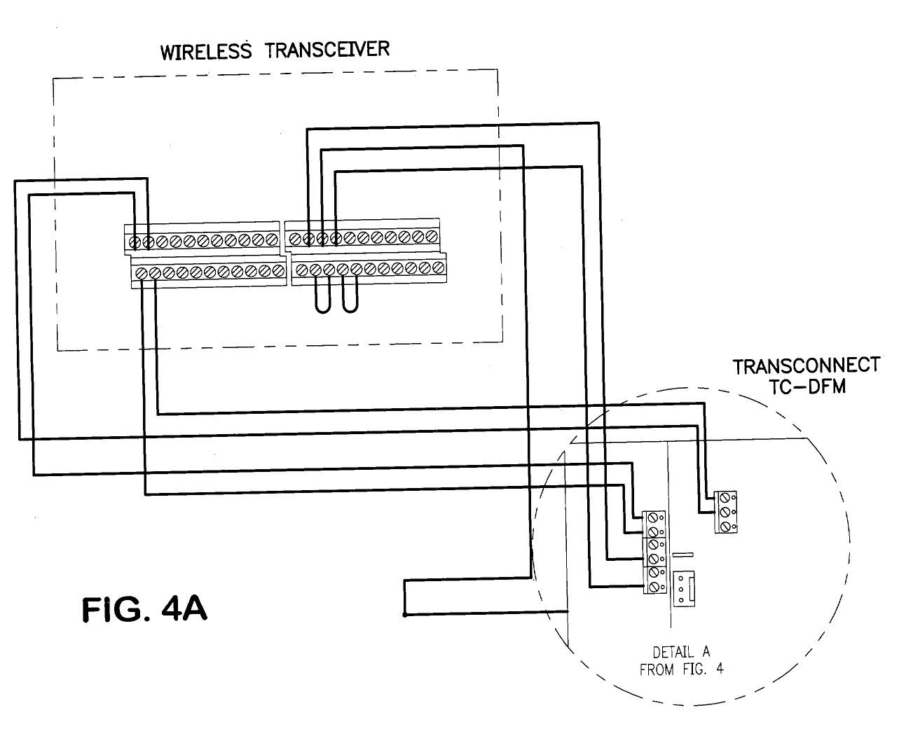

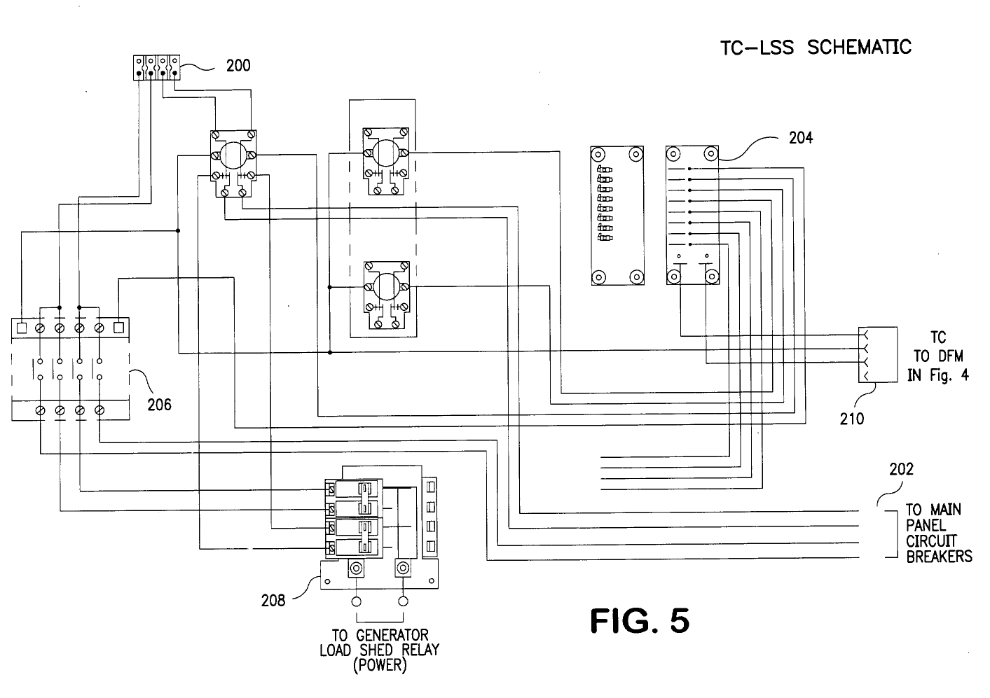

The TC-DFM as depicted in FIG. 4 consists of a microcontroller (100) having a master and slave circuit, connected to a BLP switch (102), a main board battery (104), two leads for measuring power input from the utility (120V per channel, two channels) (106). The TC-DFM measures both input voltages, as well as voltage from the generator (108). The TC-DFM also is connected to a wireless transceiver (110), and has connect terminals (112) to the generator (24) and connection to house circuit breaker (CB) panel (114). The TC-DFM works in conjunction with the TC-LSS (22) to pre-select and prioritize high current load items under control of a program. The TC-LSS (22) is connected to the TC-DFM control board via a 4-pin housing (210).

The TC-LSS, as illustrated in FIG. 5, transfers power to a plurality of load inputs (200), through load relays (206). A line in/out (202) is connect to the main panel circuit breakers, while a line from the generator (24) power source is connected via a switch to the generator load shed relay (208). A PIGLS2265 selector (204) that allows the user to select or eliminate a specific high current load through relay 1 (206) and is connected to the TC-DFM through pin connector (210).

The TC-LSS, as instructed by the microcontroller provides onsite programming capability, to allow users to configure which loads will be managed under peak shaving, and which loads will be managed during emergency outage. The capability allows users to change the configuration of the loads at any time, based on energy requirement changes to the home. This is accomplished by selecting or deselecting a load item using the selector (204)

The TC-DFM assembly is enclosed in the sub-panel (20) and is powered by the generator battery. The wireless transceiver (110) allows for a wireless connection between the ATS and the utility for remote operation and data gathering. The transceiver, as further depicted in FIG. 4A, is wired to the TC-DFM board of the ATS. This wireless device can be a cell phone, two way pager, GSM connection, or any other equivalent device with an RS232 compatible interface. The wireless transceiver requires a power of 12 VDC. In “peak shaving” mode, this wireless connection allows the utility to be able to not only monitor the ATS remotely, but also to automatically activate the BLP transfer switch (102) and generator (24) to take peak loads.

The microcontroller (100) of the TC-DFM is a standard chip that is capable of being programmed by a standard manner. The microcontroller performs the processing functions and stores in dynamic memory information such as clock time, voltage level in utility meter, voltage level in generator, battery power level, etc . . . . The microcontroller is comprised of two main chips, the master and slave. These two chips interact with each other in accordance with the instructions from the computer program.

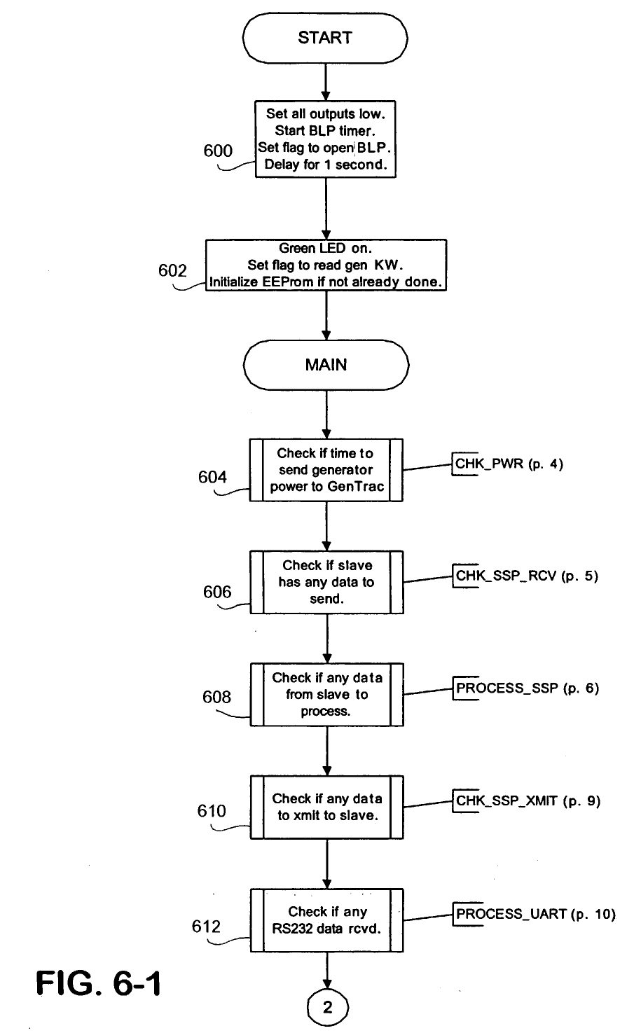

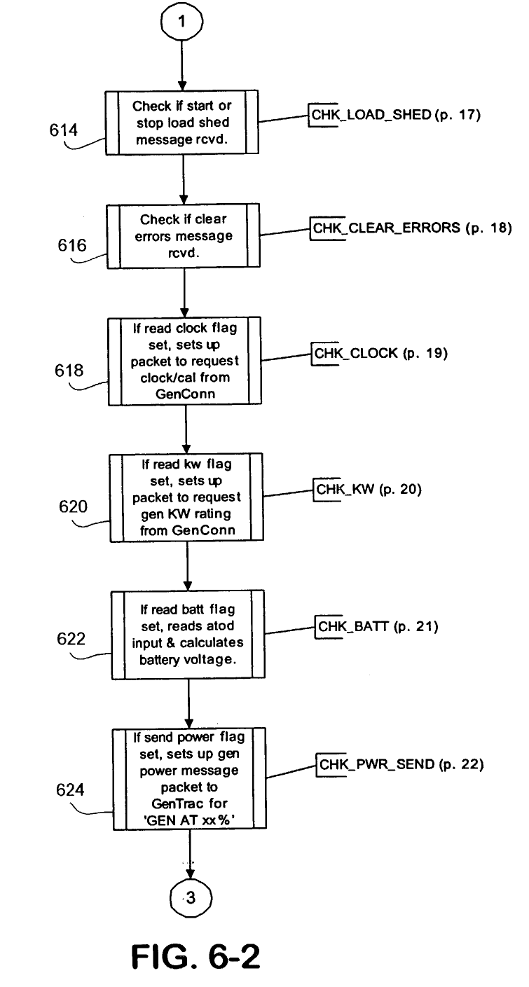

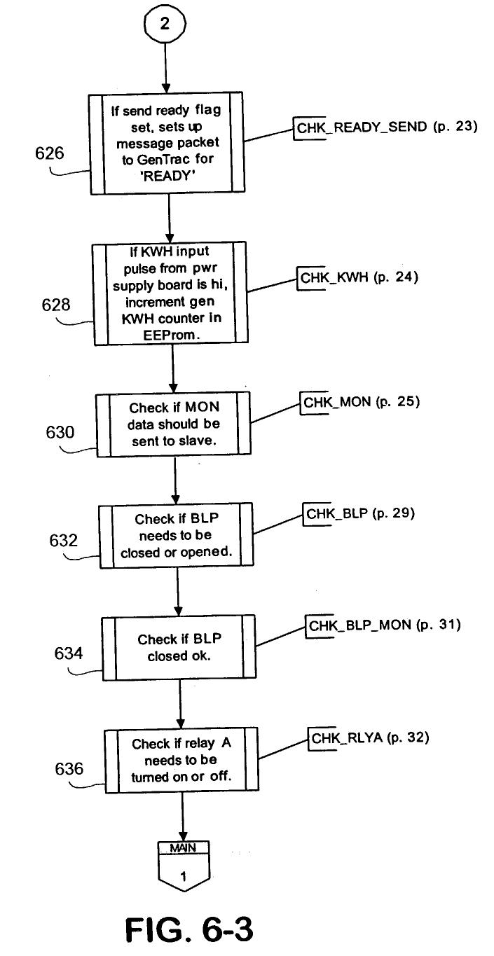

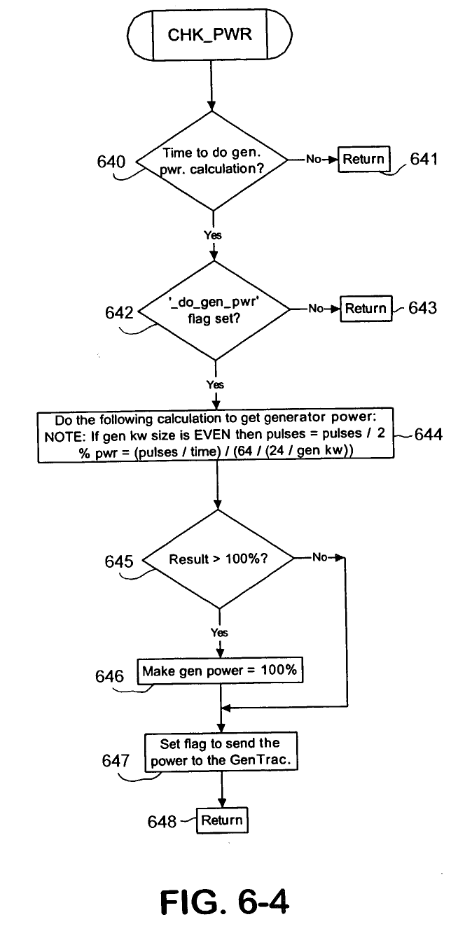

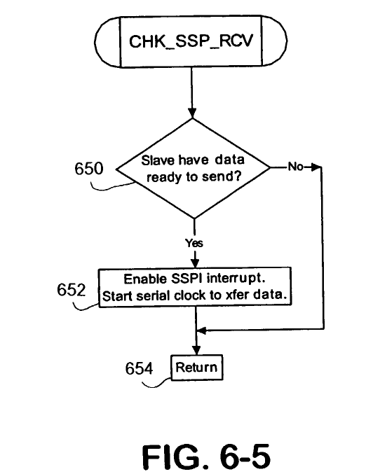

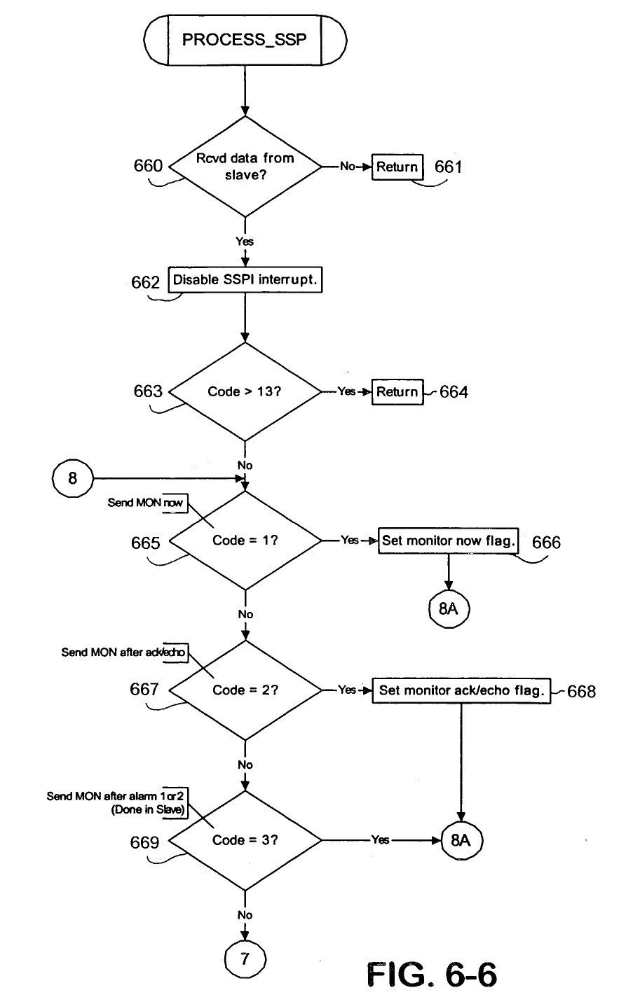

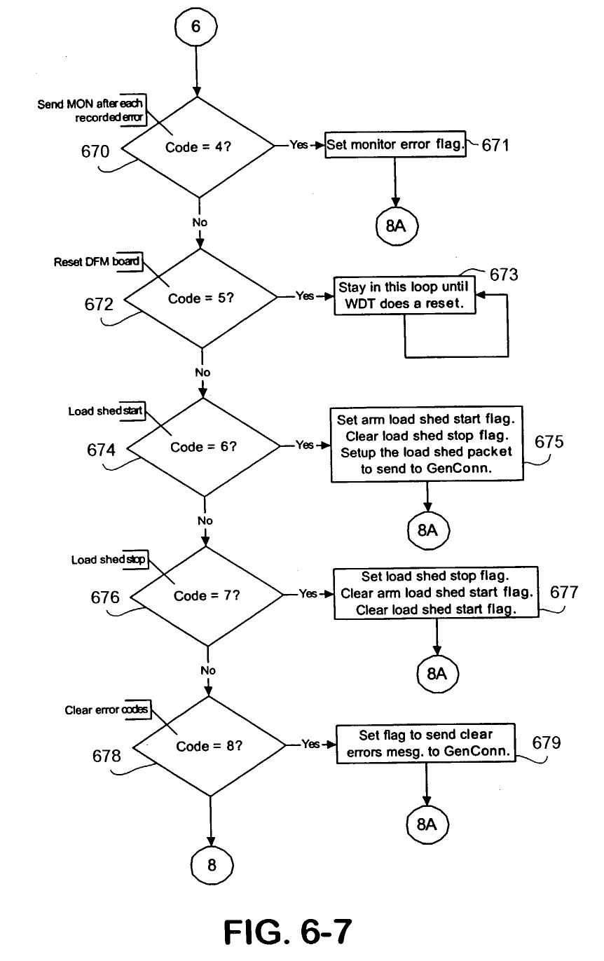

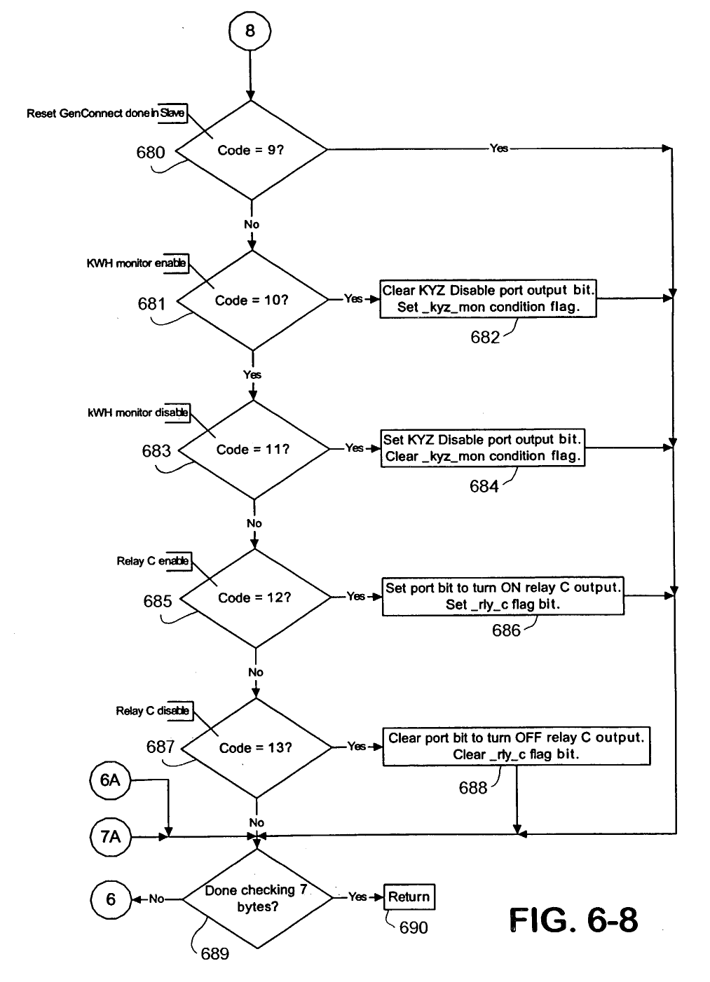

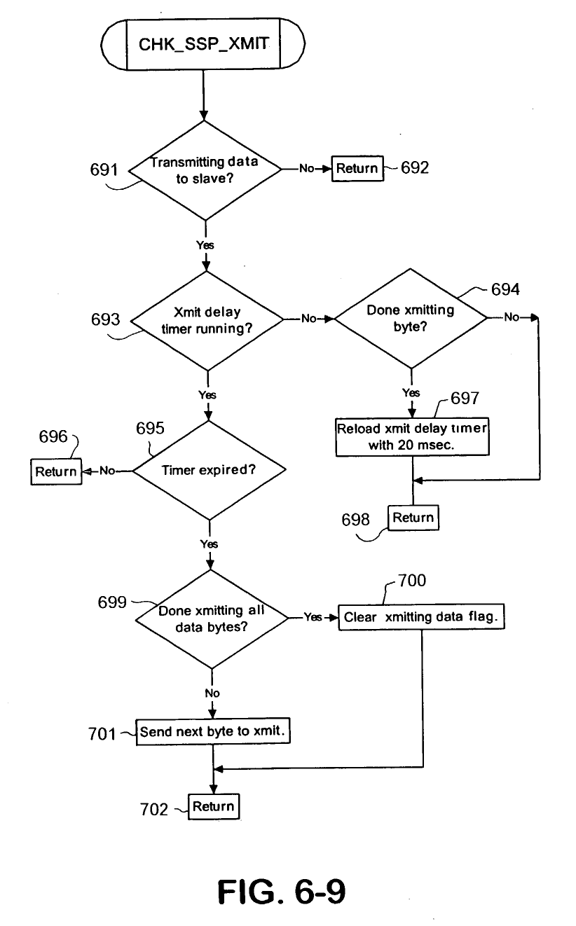

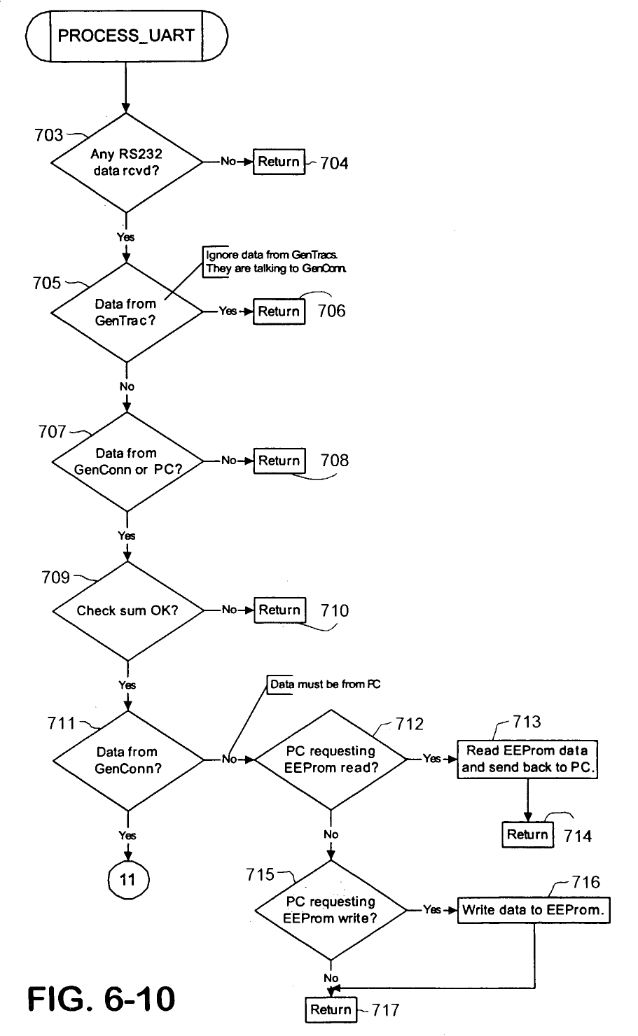

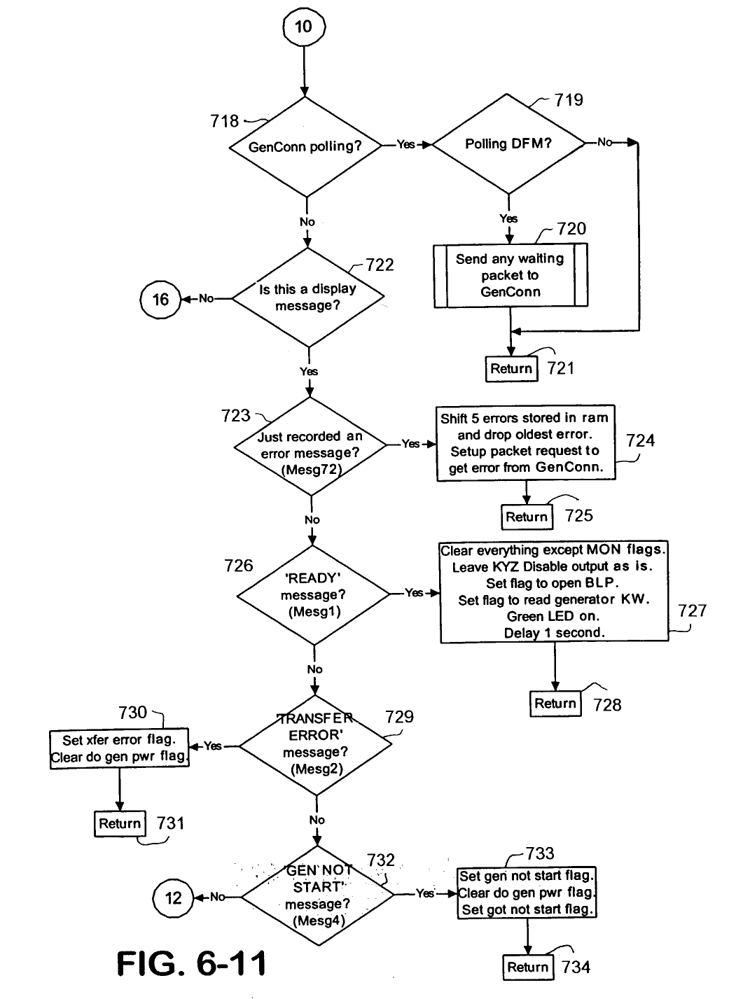

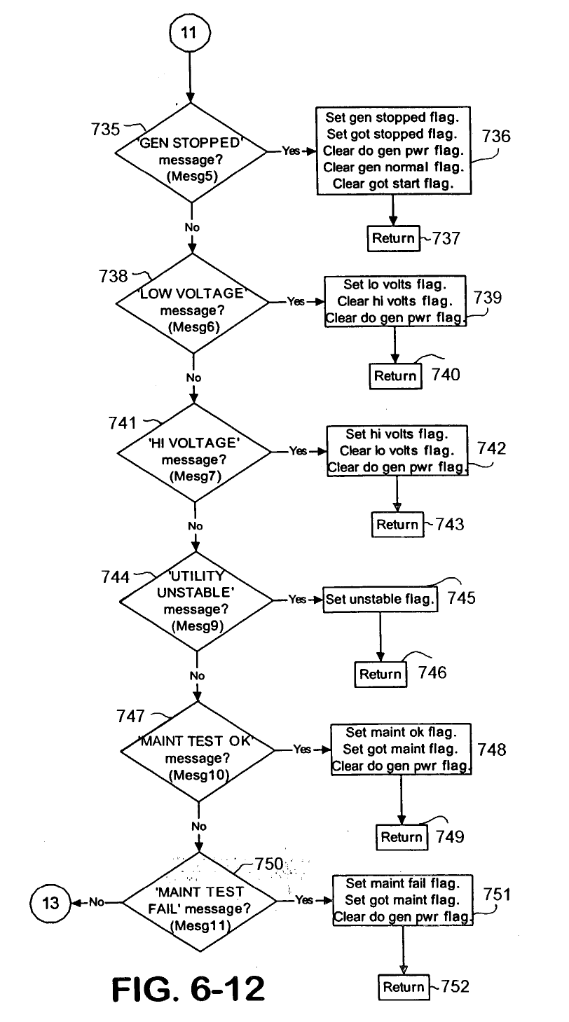

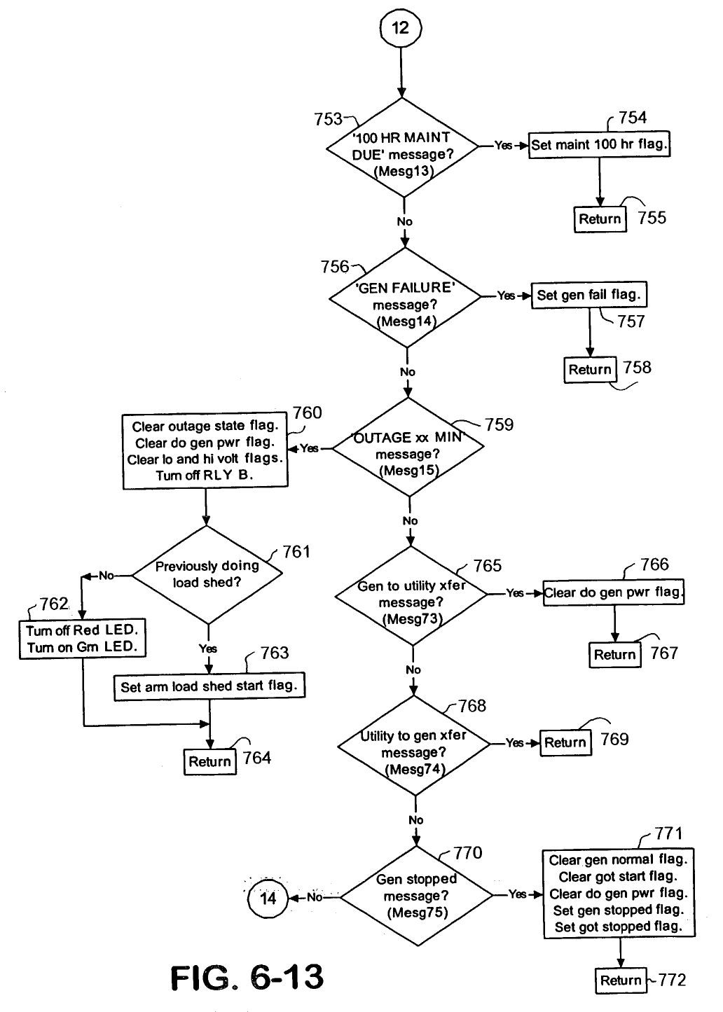

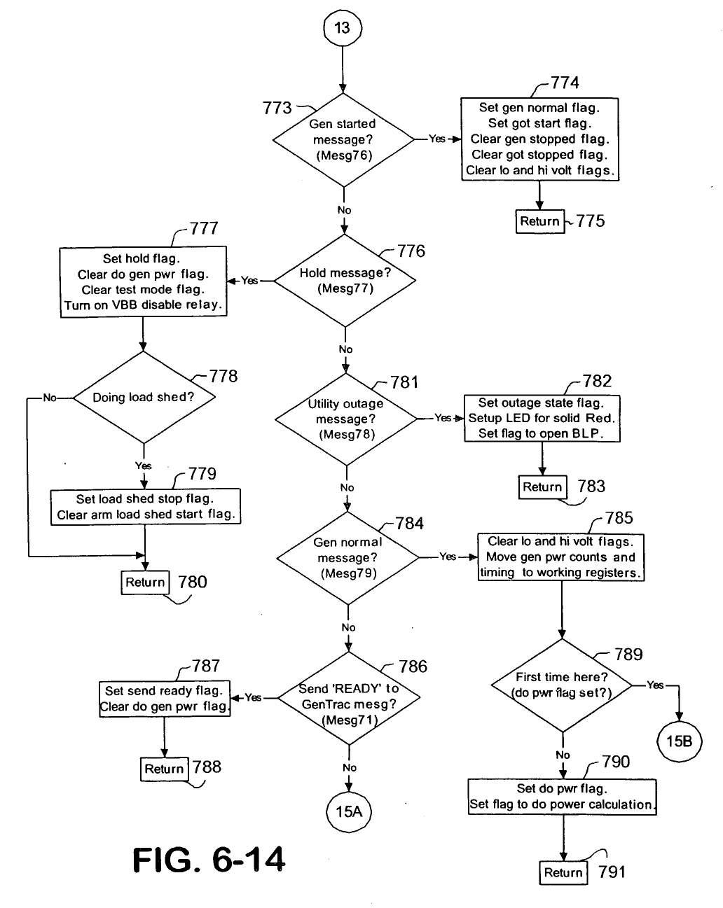

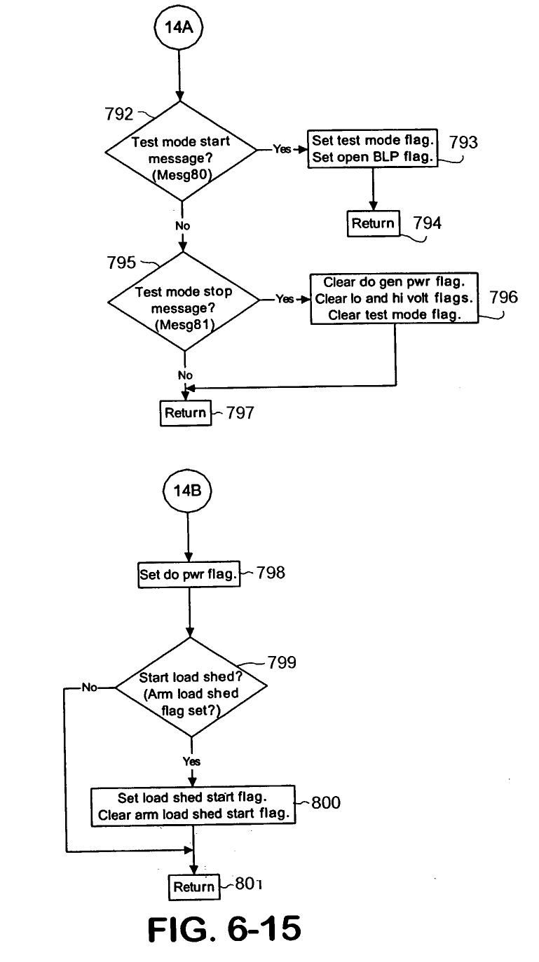

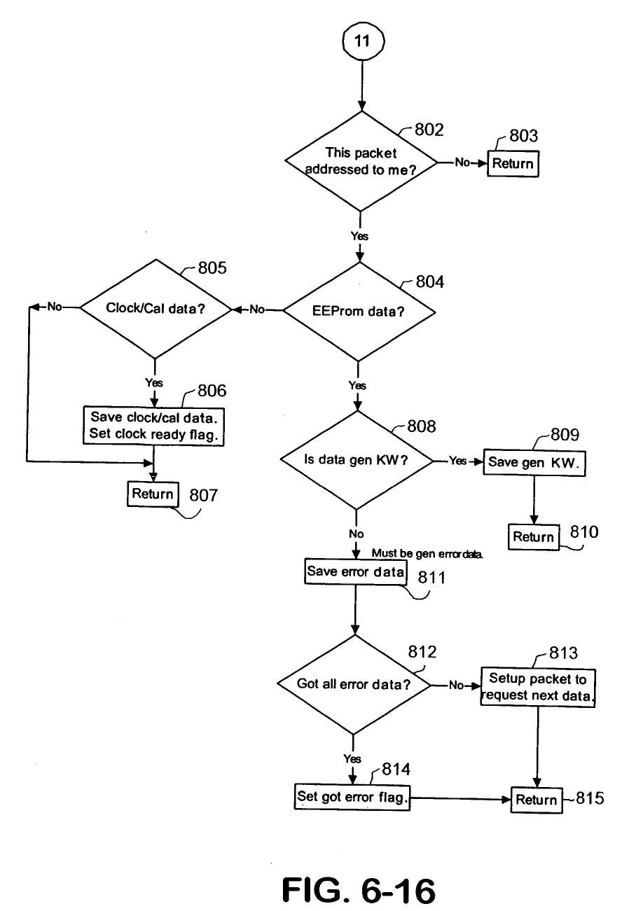

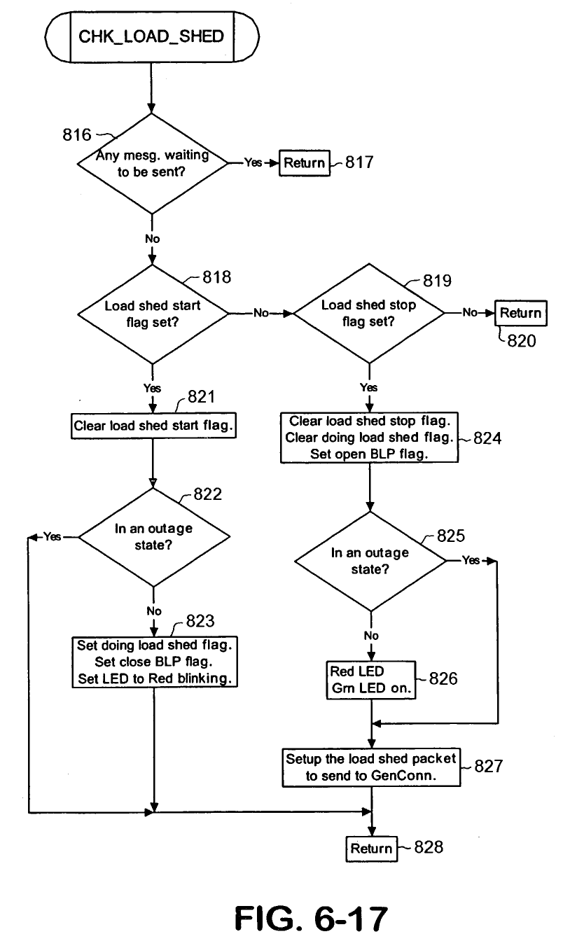

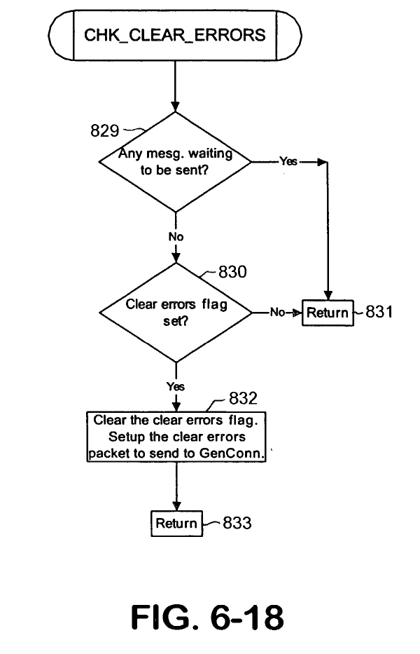

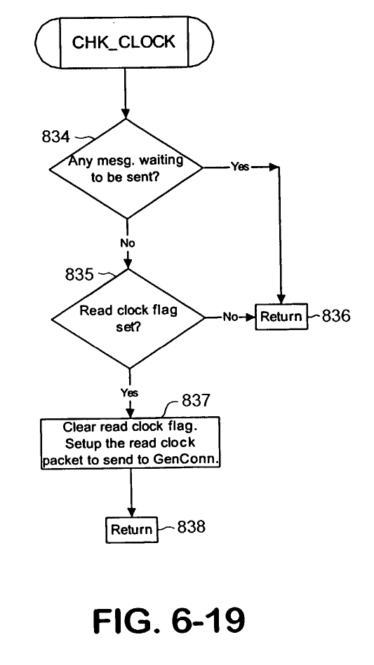

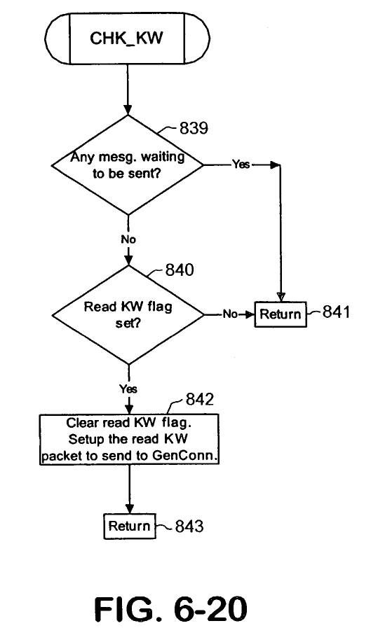

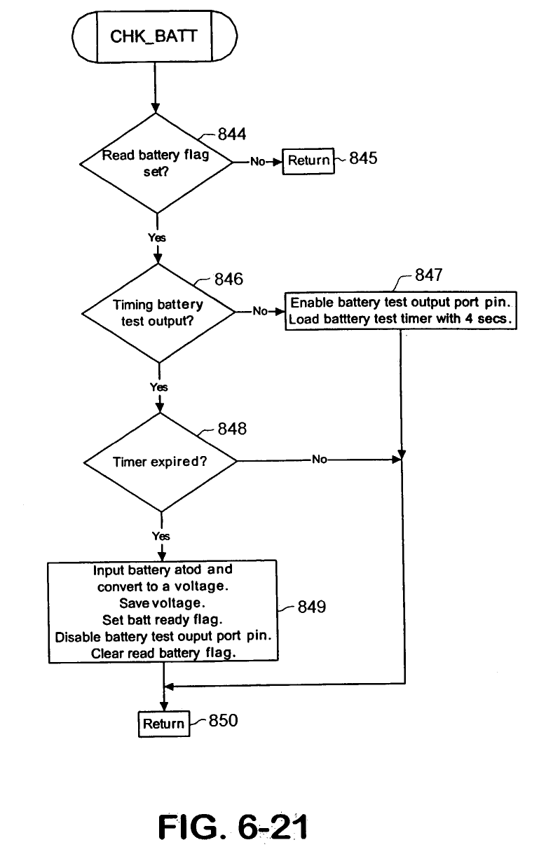

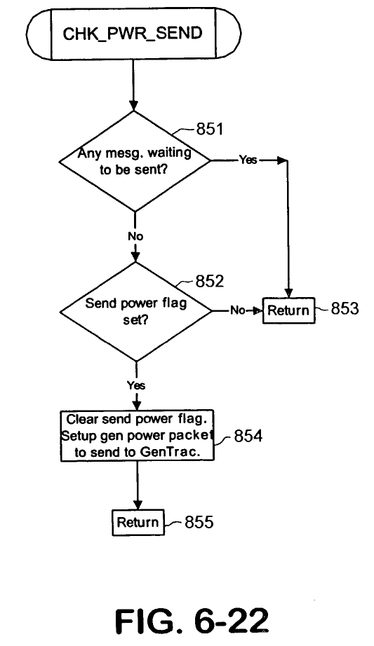

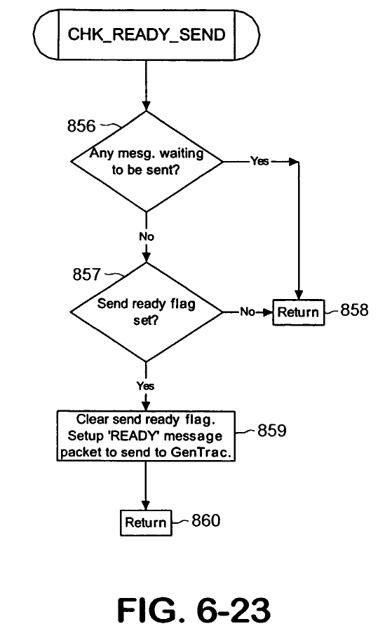

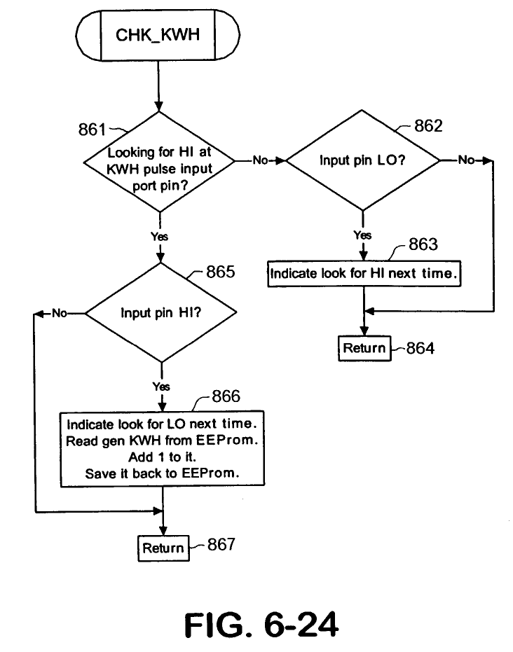

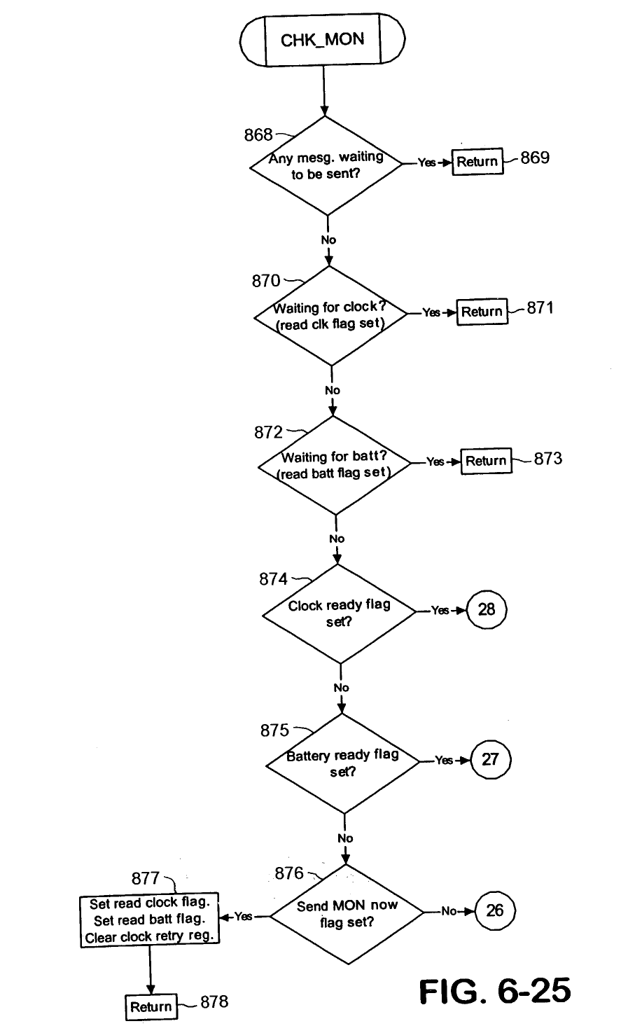

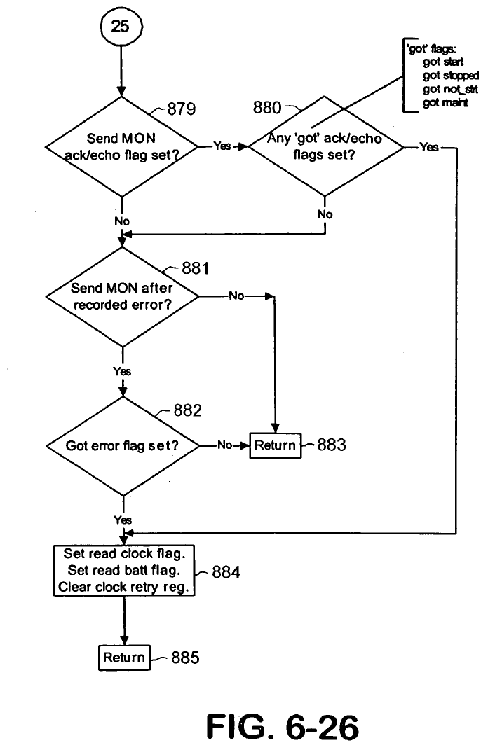

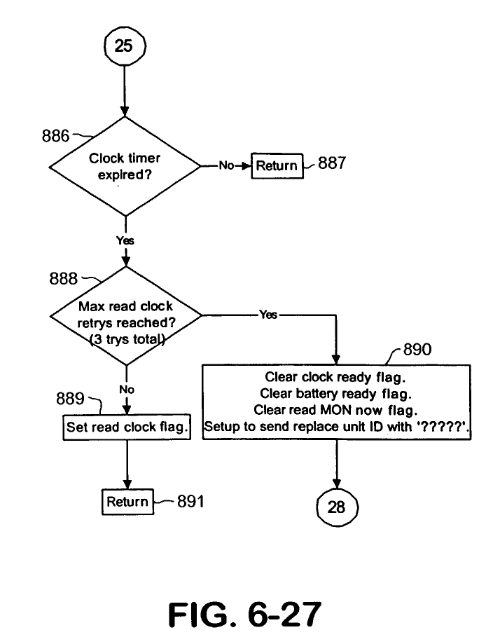

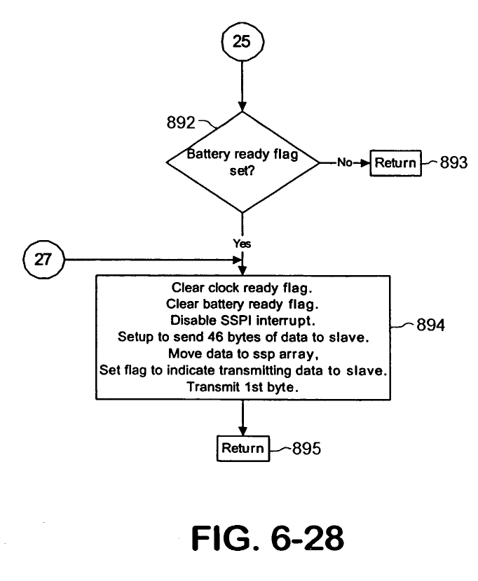

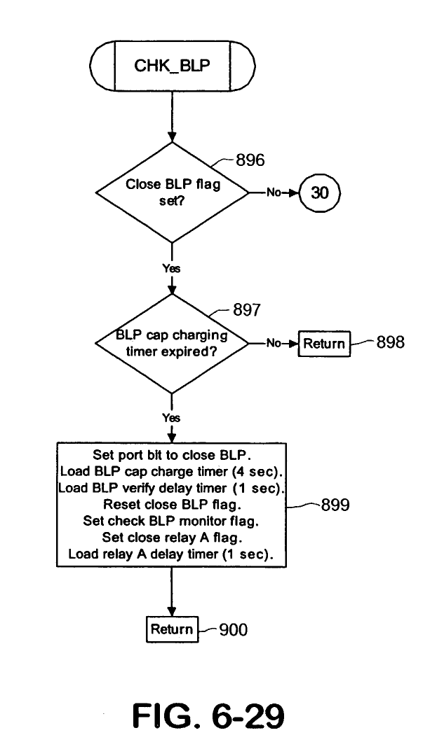

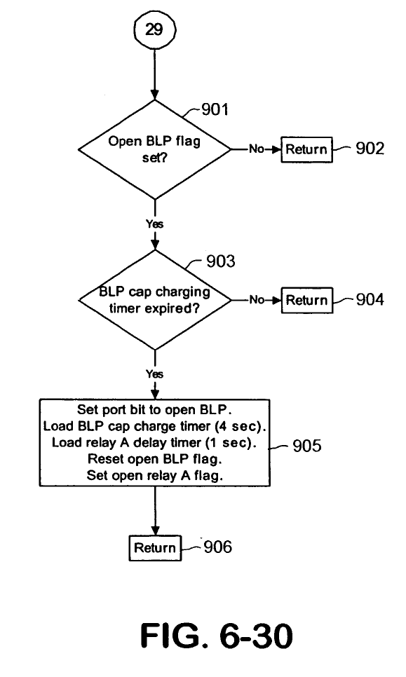

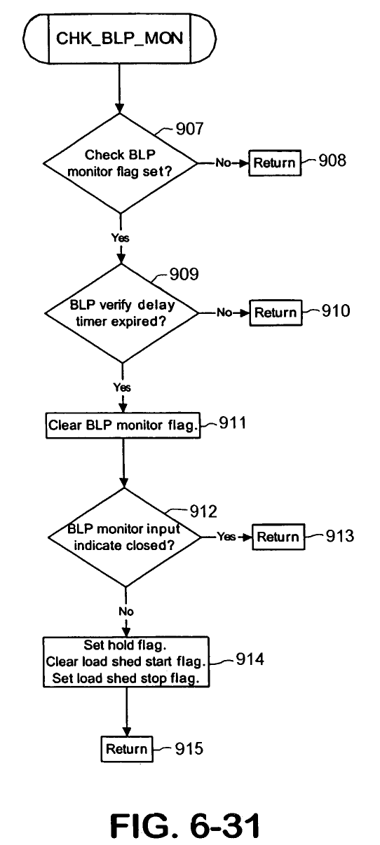

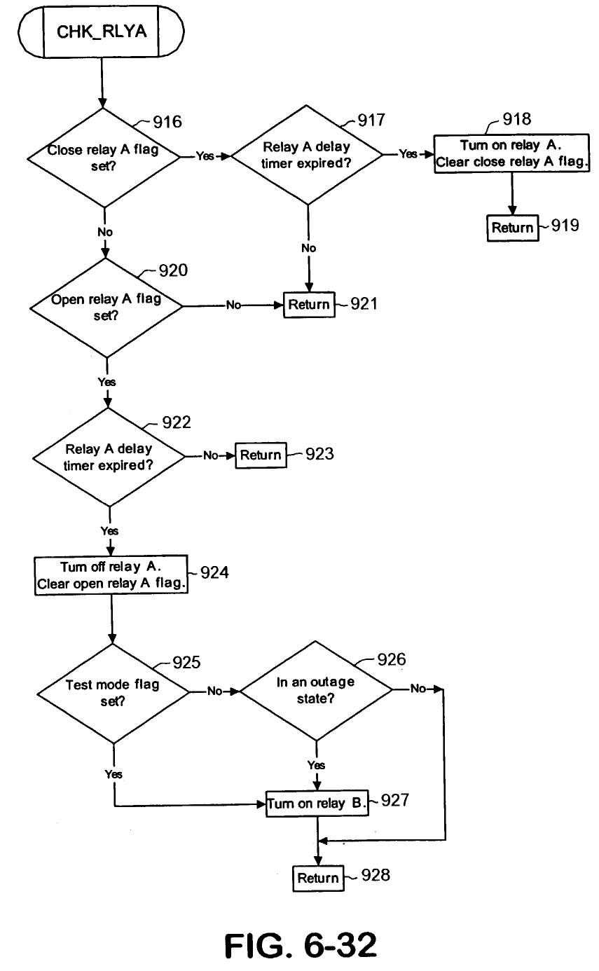

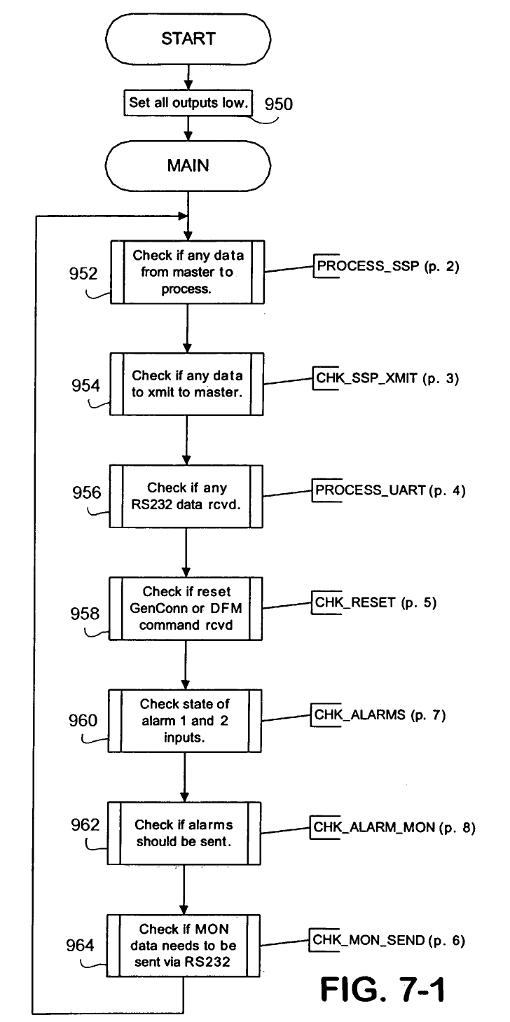

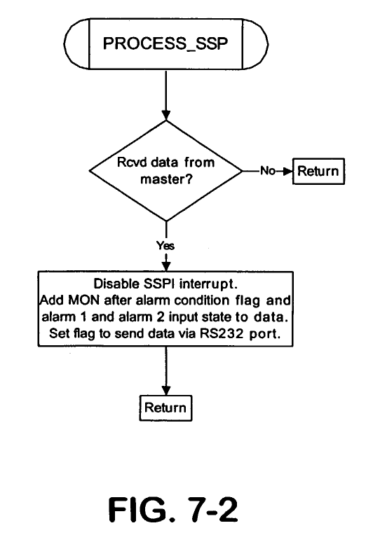

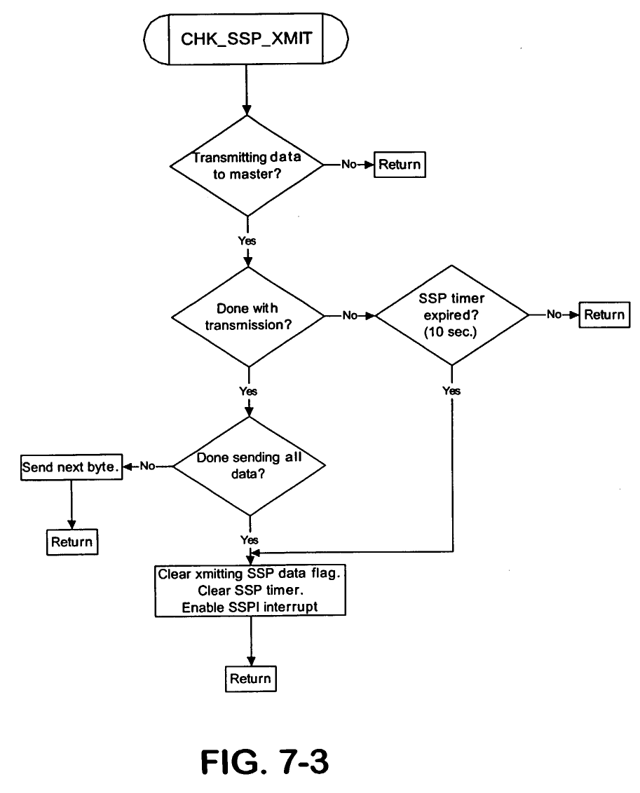

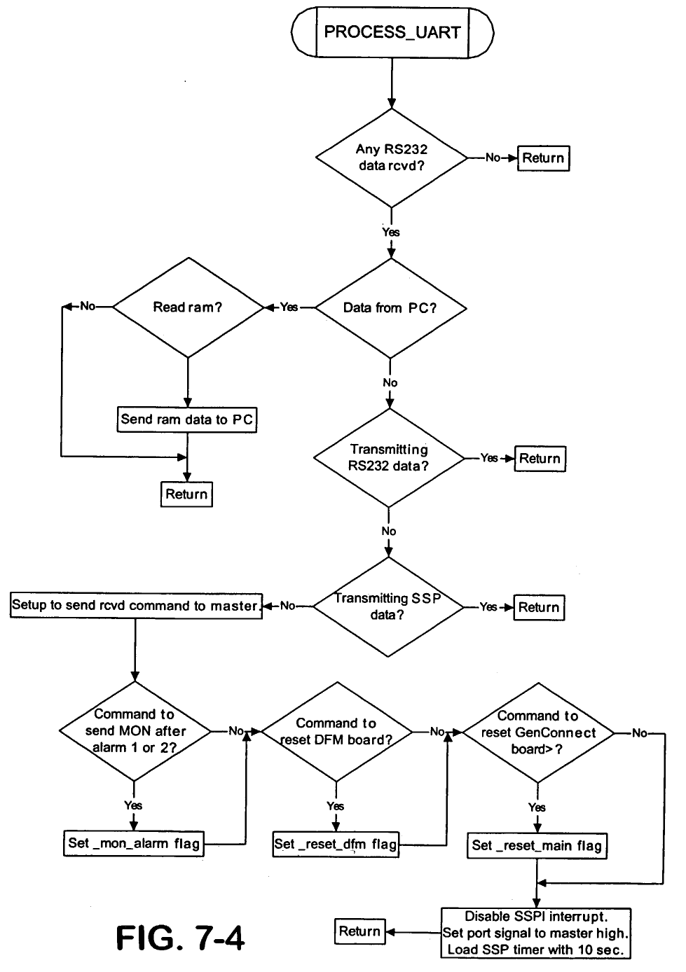

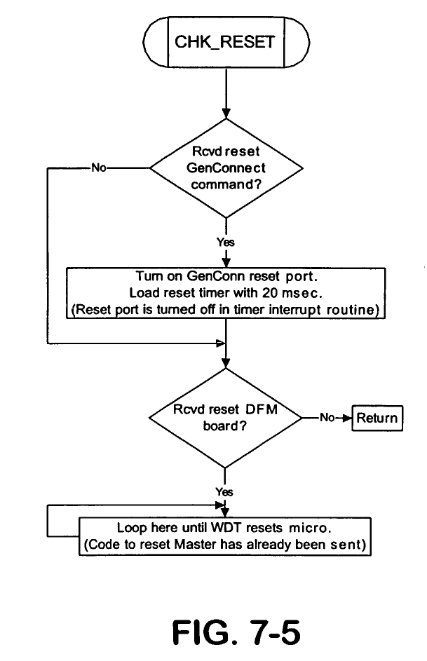

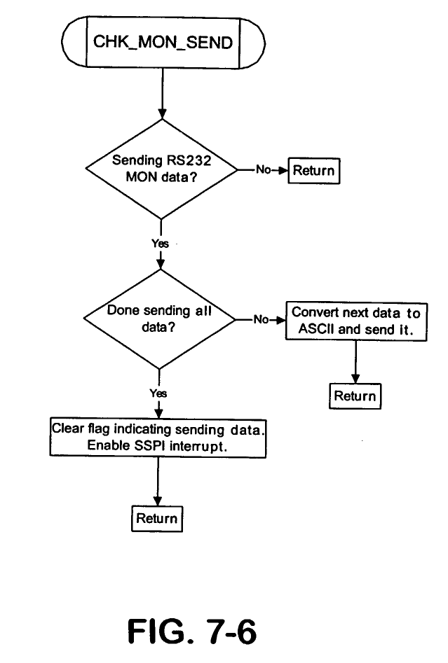

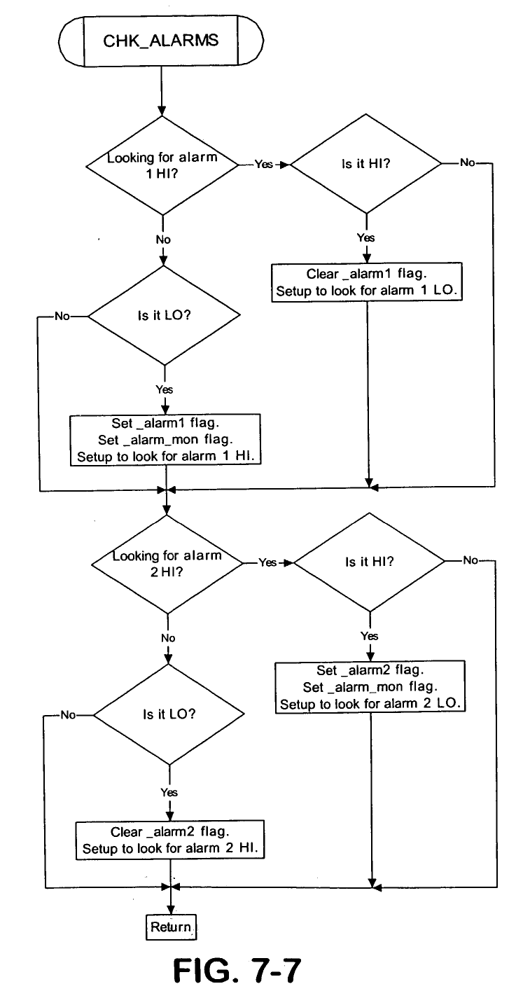

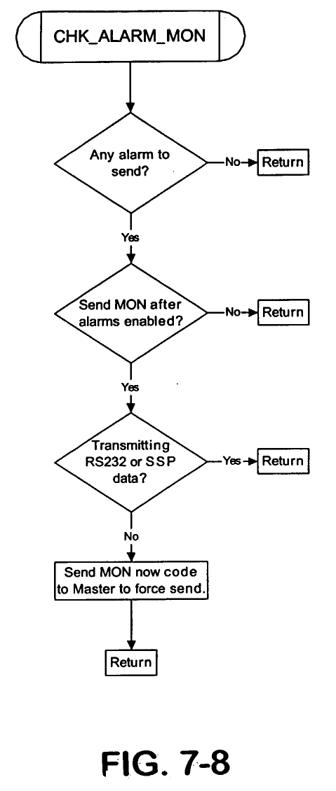

In the preferred embodiment of the invention, the microcontroller will be able to control and monitor the system by determining the voltage level of the generator (24), the load shed level, the necessity for maintenance, the date and time, whether the generator (24) is functioning properly. The microcontroller (100) follows the procedure depicted in FIG. 6., the DFM master flow chart.

The microcontroller (100) can perform two types of functions, monitoring functions and command functions. Performing these functions will be based on instructions from the utility company transmit to the microcontroller (100) via the wireless transceiver (110). An example of a monitor function is monitoring the date and time or KW generator power, maintenance test, generator fail, low voltage. The command functions include, but are not limited to, load shed start, load shed off, send error code data, send monitor data.

Initially all of the outputs of the system are set low (step 600). (A list of the output is disclosed in the attached software code) The BLP switch (102) is initialized to “open” (step 600). The switch (102) is open because during normal operation, power is coming from the utility (10) and not the generator. The BLP switch is a standard solenoid drive relay switch. The switch is closed when power is coming from the standby generator and open when power is coming from the utility. The BLP relay switch operates a 24V control supplied by the generator. The microcontroller (100) will then determine whether it is time to send generator power to GenTrac (step 604). It will run the subroutine CHK_PWR to calculate the generator power and to set a flag to send the power to the GenTrac.

The microcontroller (100) will determine if there is any information received from GenComm or DFM command, as shown in the flow chart for the DFM Slave (step 958). The master will proceed to check whether there is any data or instructions from the slave (step 606) and process said data or instructions (step 608). These instructions for example include the following: send MON now (step 665), reset DFM board (step 672), load shed start (step 674), load shed stop (step 676), etc . . . .

The microcontroller (100), according to its programming, will then check to see if any RS232 data was received (step 612) and if so, for the source of the information (steps 705 & 707). Data from GenTracs is directed towards GenComm and not DFM therefore it is ignored. If there is data received the programmed microcontroller will determine what the data was and act. (subprocedure PROCESS_UART, step 718-815). For example, in step 773 if there is a message to “get the generator started” was receive through a sending device, such as but not limited to the transceiver (110), the program will set gen normal flag, set got start flag, clear gen stopped flag, clear got stopped flag and clear lo and hi volt flags (step 774). This will cause the standby generator to start by engaged the generator start drive and its corresponding electric starter circuit.

Furthermore, if the utility outage message (step 781), mesg78 is yes then the program will set outage state flag, setup LED for solid Red, and set flag to open BLP switch (102), thus transferring power from the generator to the load (step 782). (The result of this procedure is illustrates in the voltage path in FIG. 2). The voltage path from the utility to the house breaker panel will be an “open circuit”. In this case, the generator would power the load, except the high power load items that were pre-selected for load shed. These items will be disconnected to avoid overworking the generator beyond its capacity.

A step for stopping the load shed procedure (step 779) would occur if the system received a “hold message”, as mesg77 in step 776 and would result in the load shed stop flag being set and the arm load shed start flag being cleared.

If the general normal message (step 784) is no and if send “ready” to GenTrac mesg(step 786) is also no then, the system will set the do pwr flag 798. Further, if the start load shed input is “yes” (step 799), the load shed start flag will be set and the armload shed start flag will be cleared (step 800). By setting the load shed start flag, the DFM is instructing the TC-LSS sub-panel to reconfigure the load to remove the high current items from the main utility power circuit. (load shed)

There is a step to determine if the start or stop load shed message was received from any external wireless source, such as a transceiver (step 614). In step 818 a subroutine of the program will determine if the load shed start flag is set. If said flag is set and there is no outage then the program will set the “doing load shed” flag and set the “close BLP” flag and set the “LED to RED blinking” (step 823). This also will cause the TC-LSS sub-panel to reconfigure the load and remove high current items from the main utility line.

If the load shed stop flag is set then the “load shed stop” flag is cleared, the “open BLP” flag is set and the “doing load shed” flag is cleared (step 824). This causes the load shedding process to cease. Further, if the load shed stop flag is set and there is a power outage, then the load shed packet will be setup to send to GenConn. The TC-LSS will be signaled to reconfigure the load to that the generator does not exceeds its capacity in this situation. The TC-LSS will remove the high power load from its control and power the other load items.

Besides controlling the transfer switches for the alternate power source and power load shed, the programmed microcontroller (100) monitors the utility/generator system. As depicted in FIG. 4 the TC-DFM has access to not only the generator and ATS status, but also to the utility meter itself because which is a direct result of its positioning between the meter and the breaker panel. This allows it to monitor the meter functions. The DFM program enables it to monitor the KW rating from the utility company from GenConn using leads (106). Furthermore, the AFS system allows for 15 minute profiling, a requirement of AMR applications. However, the ATS not only monitors the KW data from the meter, but also the KW data from the generator (24).

The utility company is provided important information regarding the electric efficiency of the homeowner and the level of load shaving by the homeowner. For example, it allows the utility to determine what rebate the home owner should receive for letting the utility shave load by activating the generator using this wireless system

The programmed microcontroller is also capable of obtaining other information, such as a clock/cal from GenConn (step 618) and the battery voltage (step 622). As aforementioned the control board is powered by the battery voltage, as such directly monitoring the battery power limit is necessary. The battery power is supply by the standby generator. The CHK_MON subroutine (Step 630) is designed to report the information received regarding the clock flag and battery flag to the slave (Steps 868-895).

The microprocessor also has an alarm circuit. The alarm functions to warn the user that the generator has malfunctioned. The malfunction could be that the generator did not start or that the generator has stopped. The alarm circuit signals the user remotely via the wireless transceiver. The slave chip operates the alarm signaling and is controlled by a subroutine in the slave computer program. The alarm function provides for two different alarms, alarm 1 and alarm 2. If either alarm is HI, then the generate system has malfunctioned.

This ATS system, with its unique sub-panel design and control panel, allows the generator loads to be reconfigured automatically, based on whether the generator is meeting a pea shaving request, or responding to an emergency outage and thus provides the maximum security and comfort for the house owner in terms of load management and the prevention of brown and blackouts.

While this invention has been described in conjunction with specific embodiments outlined above, it is evident that many alternatives, modifications and variations will be apparent to those skilled in the art. Accordingly, the preferred embodiments of the invention, as set forth above, are intended to be illustrative, not limiting and various changes may be made without departing from the true spirit and full scope of the invention as defined in the appended claims.

What is claimed is:

1. A utility power source management system for a plurality of residential units that allows for both an alternative power source to be connected to the residential unit in the event of a power outage, as well as for a load shedding by connecting selecting high current loads of a residential unit to the alternative power source during peak demand periods comprising:
a plurality of electrical utility inputs;
a plurality of electrical utility outputs adapted to be connected respectively to the utility inputs and to a plurality of loads in a residential unit;
a standby generator unit having an output connect to the residential unit;
a switch connected between an electrical utility output and the generator output, said switch being configured to be activated between two positions to connect either the electrical utility output or the generator output to supply power to the residential unit;
a programmed microcontroller at each residential unit for controlling power distribution in said unit;
a wireless transceiver at each residential unit for remotely receiving and transmitting information from a utility source to control the application of power from the utility source to the residential unit.

2. A wireless automatic transfer control apparatus that allows for both an alternative power source to be connected to a residential unit in the event of a power outage as well as for load shedding by disconnecting selected high current loads from a main power source and connecting said disconnected loads to the alternate power source during peak demand periods comprising,
a plurality of electrical utility inputs;
a plurality of electrical utility outputs adapted to be connected respectively to a plurality of residential loads of a residential unit,
a standby generator unit for providing the alternative power source and having an output adapted to be selectively connected to the loads of the residential unit;
a switch connected between the main power source and the generator output, said switch being configured to be activated between two positions to connect either the main power source or the generator output to supply power to the residential unit;
a programmed microcontroller at each residential unit for controlling power distribution in said unit;
a wireless transceiver at each residential unit for remotely transmitting information to and from the microcontroller wherein the microcontroller, upon receiving said information controls the application of power from the main and alternative power sources to the residential unit.

3. A sub-panel assembly for controlling transfer of power to a plurality of load items from a utility power source and a standby generator power source comprising:
a programmed control board disposed within the sub panel;
a plurality of electrical utility outputs adapted to be connected to pre-selected loads of the residential unit,
a selector connected to the control board and operably configured to select between pre-selected load items such that any and all of the load will receive power from the standby generator and not from the utility power source; said control board being responsive to wireless commands from a utility for controlling transfer of power between the utility power source and the standby generator power source whereby high power load items are disconnected from the utility power source, thus lowering the total demand on the utility power source during peak demand periods.
